(19) United States
(12) Patent Application Publication
(10) Pub. No.: US 2019/0023509 A1
(43) Pub. Date: Jan. 24, 2019

(54) SUPPLY UNIT AND IMAGE FORMING APPARATUS

(71) Applicant: CANON KABUSHIKI KAISHA, Tokyo (JP)

(72) Inventors: Kentarou Tomoe, Susono-shi (JP); Yasuhiko Fuse, Mishima-shi (JP)

(21) Appl. No.: 16/138,464

(22) Filed: Sep. 21, 2018

Related U.S. Application Data
(63) Continuation of application No. 15/339,507, filed on Oct. 31, 2016, now Pat. No. 10,106,348.

(30) Foreign Application Priority Data
Nov. 5, 2015 (JP) 2015-217188

(51) Int. Cl. B65H 3/06; G03G 21/16; G03G 15/00

(52) U.S. Cl. CPC B65H 3/0684; B65H 2801/09; B65H 2402/515; B65H 2402/10; G03G 21/1695; G03G 15/6511; G03G 15/6502; G03G 21/1633; B65H 2801/12; B65H 2601/324

(57) ABSTRACT

A supply unit holds a supply unit including a pickup roller for supplying a sheet, enables the supply unit including the pickup roller to be installed into an image forming apparatus, and includes a roller-protecting member. The roller-protecting member has a roller-protecting surface that covers the pickup roller of the supply unit and includes engaging pawls that can engage and integrally hold the supply unit including the pickup roller with the roller-protecting surface covering the pickup roller.

### CROSS-REFERENCE TO RELATED APPLICATIONS

This application is a continuation, and claims the benefit, of U.S. patent application Ser. No. 15/339,507, presently pending and filed on Oct. 31, 2016, and claims the benefit of, and priority to, Japanese Patent Application No. 2015-217188, filed Nov. 5, 2015, which applications are hereby incorporated by reference herein in their entireties.

### BACKGROUND OF THE INVENTION

### Field of the Invention

The present invention relates to a supply unit used when a supplier is installed, an image forming apparatus of, for example, an electrophotographic type or an electrostatic recording type that can use the supply unit, and a supplier installing method.

### Description of the Related Art

In a known image forming apparatus, sheets (recording media) stacked in a sheet feed cassette are supplied by a supply roller one by one. A surface of the supply roller (supplier) is subjected to wear and tear and deteriorates through continuous use, and a supply failure may consequently occur. In view of this, in the case where the lifetime of the roller is shorter than the lifetime of an image forming apparatus body (also referred to as an apparatus body below), a user can typically carry out a replacing operation so that the user (operator) can replace the roller with a new one.

An example that enables a user to replace the supply roller is as follows. Japanese Patent Laid-Open No. 2001-294335 proposes a sheet separating and conveying device in which a supply unit, which includes a supply roller and a feed roller, is detachably installed into a device body.

However, with a structure in which the supply unit including the supply roller is detachably installed into the device body as disclosed in Japanese Patent Laid-Open No. 2001-294335, it is difficult for a user to know how to hold the supply unit, and there is a possibility that the user will install the supply unit into the device body while holding a roller portion. When the user touches the roller portion during installation, impurities may become attached to the surface of the roller, which may damage the roller. Consequently, a supply failure may occur.

### SUMMARY OF THE INVENTION

The present invention provides a supply unit that enables a user to readily install the supply unit without touching a surface of a supplier during installation and enables a failure in installation to be inhibited during installation of the supplier, and an image forming apparatus that can use the supply unit.

The present invention provides a supply unit that is to be installed into an image forming apparatus. The supply unit includes a supply member that supplies a sheet, a unit body that includes an engaged portion to be engaged and supports the supply member, and a cover member that includes a cover portion that covers the supply member and an engaging portion that is to engage the engaged portion. The supply unit is installed into the image forming apparatus with the engaging portion engaging the engaged portion and the cover portion covering the supply member. The present invention also provides an image forming apparatus in which a supply unit is to be detachably installed. The image forming apparatus includes an installation portion, and a supply unit that is to be installed into the installation portion and includes a supply member that supplies a sheet, a unit body that includes an engaged portion to be engaged and supports the supply member, a cover member that includes a cover portion that covers the supply member and an engaging portion that is to engage the engaged portion. The supply unit is installed into the installation portion with the engaging portion engaging the engaged portion and the cover portion covering the supply member.

Further features of the present invention will become apparent from the following description of exemplary embodiments with reference to the attached drawings.

### BRIEF DESCRIPTION OF THE DRAWINGS

FIG. 1 is a schematic view of an image forming apparatus according to a first embodiment of the present invention.

FIG. 2A is a perspective view of a sheet-supplying device according to the first embodiment viewed from below.

FIG. 2B is a perspective view of the sheet-supplying device illustrated in FIG. 2A viewed at a different angle.

FIG. 3 is a perspective view of the sheet-supplying device illustrated in FIG. 2A viewed from above.

FIG. 4 is a perspective diagram illustrating the appearance of a supply unit according to the first embodiment.

FIG. 5 is a perspective diagram illustrating the appearance of the supply unit and the sheet-supplying device according to the first embodiment.

FIG. 6A is a sectional view of FIG. 5 along line M-M, in the direction of arrows.

FIG. 6B is a sectional view of FIG. 5 along line N-N, in the direction of arrows.

FIG. 6C is a sectional view of FIG. 5 along line M-M, in the direction of the arrows, when a sliding end portion of a slide shaft is inserted into a slide hole of a feed roller.

FIG. 6D is a sectional view of FIG. 5 along line N-N, in the direction of the arrows, when the sliding end portion of the slide shaft is inserted into the slide hole of the feed roller.

FIG. 7A is a sectional view of FIG. 5 along line M-M, in the direction of the arrows, before the supply unit is installed in a normal state with respect to the sheet-supplying device.

FIG. 7B is a sectional view of FIG. 5 along line N-N, in the direction of the arrows, before the supply unit is installed in a normal state with respect to the sheet-supplying device.

FIG. 7C is a sectional view of FIG. 5 along line M-M, in the direction of the arrows, when the supply unit is installed into the sheet-supplying device.

FIG. 7D is a sectional view of FIG. 5 along line N-N, in the direction of the arrows, when the supply unit is installed into the sheet-supplying device.

FIG. 8A is a sectional view of FIG. 5 along line M-M, in the direction of the arrows, when a roller-protecting member is detached from the supply unit.

FIG. 8B is a sectional view of FIG. 5 along line M-M, in the direction of the arrows, when the roller-protecting member is detached from the supply unit.

FIG. 9 is a front view of the sheet-supplying device of the image forming apparatus according to the first embodiment and the vicinity thereof.

FIG. 10 is a perspective diagram illustrating the appearance of a supply unit according to a second embodiment.

FIG. 11 is a perspective diagram illustrating the appearance of the supply unit and a sheet-supplying device according to the second embodiment.

FIG. 12A is a sectional view of FIG. 11 along line V-V, in the direction of arrows.

FIG. 12B is a sectional view of FIG. 11 along line W-W, in the direction of arrows.

FIG. 12C is a sectional view of FIG. 11 along line V-V, in the direction of the arrows, when a sliding end portion of a slide shaft is inserted into a slide hole of a feed roller.

FIG. 12D is a sectional view of FIG. 11 along line W-W, in the direction of the arrows, when the sliding end portion of the slide shaft is inserted into the slide hole of the feed roller.

FIG. 13A is a sectional view of FIG. 11 along line V-V, in the direction of the arrows, before the supply unit is installed in a normal state with respect to the sheet-supplying device.

FIG. 13B is a sectional view of FIG. 11 along line W-W, in the direction of the arrows, before the supply unit is installed in a normal state with respect to the sheet-supplying device.

FIG. 13C is a sectional view of FIG. 11 along line V-V, in the direction of the arrows, when the supply unit is installed into the sheet-supplying device.

FIG. 13D is a sectional view of FIG. 11 along line W-W, in the direction of the arrows, when the supply unit is installed into the sheet-supplying device.

### DESCRIPTION OF THE EMBODIMENTS

### First Embodiment

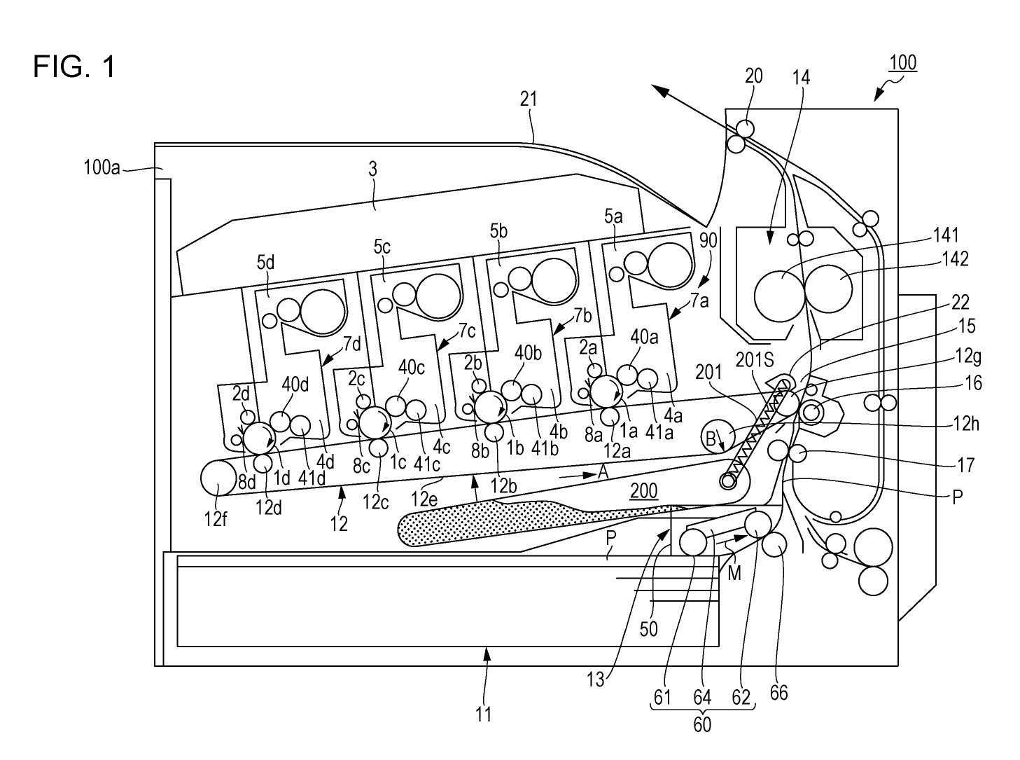

Embodiments of the present invention will hereinafter be described with reference to the drawings. In the description, a positional relationship in the up, down, left, and right directions is represented on the basis of a state where an image forming apparatus 100 is viewed from the front (viewpoint of FIG. 1). A supplier installing method according to the present invention will be described in a description of processing steps in the image forming apparatus 100.

### Structure of Image Forming Apparatus and Image Forming Process

The structure of the image forming apparatus 100 and imaging processes according to the first embodiment of the present invention will now be described. FIG. 1 is a schematic sectional view of the image forming apparatus 100 according to the first embodiment.

As illustrated in FIG. 1, the image forming apparatus 100 includes an image forming apparatus body 100a (also referred to as an apparatus body below) and process cartridges 7a, 7b, 7c, and 7d that are attachable to and detachable from the apparatus body 100a. The four process cartridges 7a to 7d have the same structure but differ in forming images of different colors, that is, yellow (Y), magenta (M), cyan (C), and black (Bk) toners. The process cartridges 7a to 7d each include development units 4a, 4b, 4c, and 4d and toner units 5a, 5b, 5c, and 5d.

The development units 4a, 4b, 4c, and 4d each include photosensitive drums 1a, 1b, 1c, and 1d, which are image-bearing members, charge rollers 2a, 2b, 2c, and 2d, drum cleaning blades 8a, 8b, 8c, and 8d, and a waste-toner container. The development units 4a, 4b, 4c, and 4d also include development rollers 40a, 40b, 40c, and 40d and developer-applying rollers 41a, 41b, 41c, and 41d. A scanner unit 3 is disposed above the process cartridges 7a, 7b, 7c, and 7d. The scanner unit 3 exposes the photosensitive drums 1a, 1b, 1c, and 1d to light on the basis of image signals.

The photosensitive drums 1a, 1b, 1c, and 1d are charged by the charge rollers 2a, 2b, 2c, and 2d at a predetermined potential having a negative polarity. Electrostatic latent images are then formed on the photosensitive drums by the scanner unit 3. The electrostatic latent images are subjected to reversal development by the corresponding development units 4a, 4b, 4c, and 4d, and toners having a negative polarity are attached thereto, forming toner images of Y, M, C, and Bk thereon.

In an intermediate transfer belt unit 12, an intermediate transfer belt 12e is tightly stretched around a drive roller 12f, an opposing secondary-transfer roller 12g, and a tension roller 12h. The tension roller 12h applies tension in the direction of arrow B. Primary transfer rollers 12a, 12b, 12c, and 12d are disposed inside the intermediate transfer belt 12e so as to oppose the photosensitive drums 1a, 1b, 1c, and 1d. A bias applying unit, not illustrated, applies transfer bias.

In the image forming apparatus 100, a supply unit 600, described later, enables a supply unit 60 to be installed (replaced). The image forming apparatus 100 includes a sheet feed cassette 11 (sheet-containing unit) and an image-forming unit 90 that forms an image on a sheet supplied from the sheet feed cassette 11. The sheet feed cassette 11 is to be installed into and to be drawn from the apparatus body 100a and contains sheets P (recording materials) to be supplied by using a pickup roller 61.

The photosensitive drums rotate in the direction of arrows. The intermediate transfer belt 12e rotates in the direction of arrow A. Bias having a positive polarity is applied to the primary transfer rollers 12a, 12b, 12c, and 12d. The toner images formed on the photosensitive drums 1a, 1b, 1c, and 1d are primarily transferred successively on the intermediate transfer belt 12e starting from the toner image on the photosensitive drum 1a. The overlapping four-color toner images are conveyed to a secondary transfer unit 15.

The sheet P conveyed from a sheet-supplying device 13 passes through a pair of registration rollers 17 and is conveyed to the secondary transfer unit 15. The sheet-supplying device 13 includes the supply unit 60 and a retard roller 66 serving as a separation unit (separation roller) that faces a feed roller 62 and is in pressure contact with the feed roller 62. The supply unit 60 includes the pickup roller 61 serving as a supplier (supply roller) that supplies the sheet P from the inside of the sheet feed cassette 11 containing the sheets P and the feed roller 62 serving as a conveyor (conveyance roller) that conveys the supplied sheet. The supply unit 60 also includes an idler gear 63, described later, and a supply holder 64 that holds these. The detail of the sheet-supplying device 13 is described later.

At the secondary transfer unit 15, bias having a positive polarity is applied to a secondary transfer roller 16 to secondarily transfer the four-color toner images formed on the intermediate transfer belt 12e to the conveyed sheet P. The sheet P on which the toner images are transferred is conveyed to a fixing device 14, heated and pressed by a fixing roller 141 and a pressure roller 142, and fixed on a surface of the sheet. The sheet P on which the toner images are fixed is discharged to a discharge tray 21 by a pair of discharge rollers 20. Residual toners remaining on the surfaces of the photosensitive drums 1a, 1b, 1c, and 1d after the toner images are transferred are removed by the cleaning blades 8a, 8b, 8c, and 8d, respectively. A residual toner remaining on the intermediate transfer belt 12e after the secondary transfer to the sheet P is removed by a transfer-belt-cleaning device 22. The removed toners pass through a waste-toner conveyance path 201 and are collected in a waste-toner container 200.

### Structure of Sheet-Supplying Device

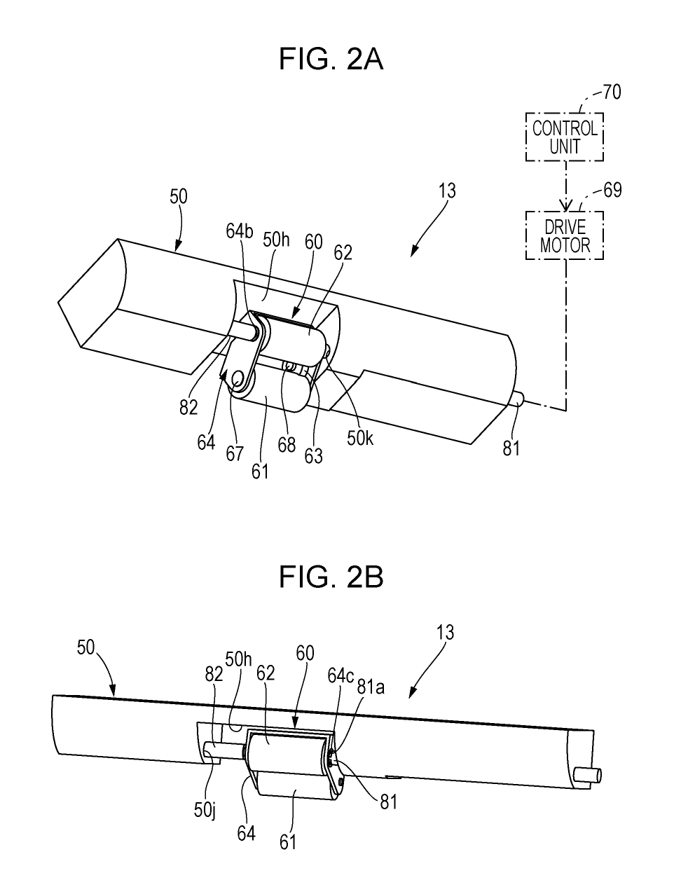

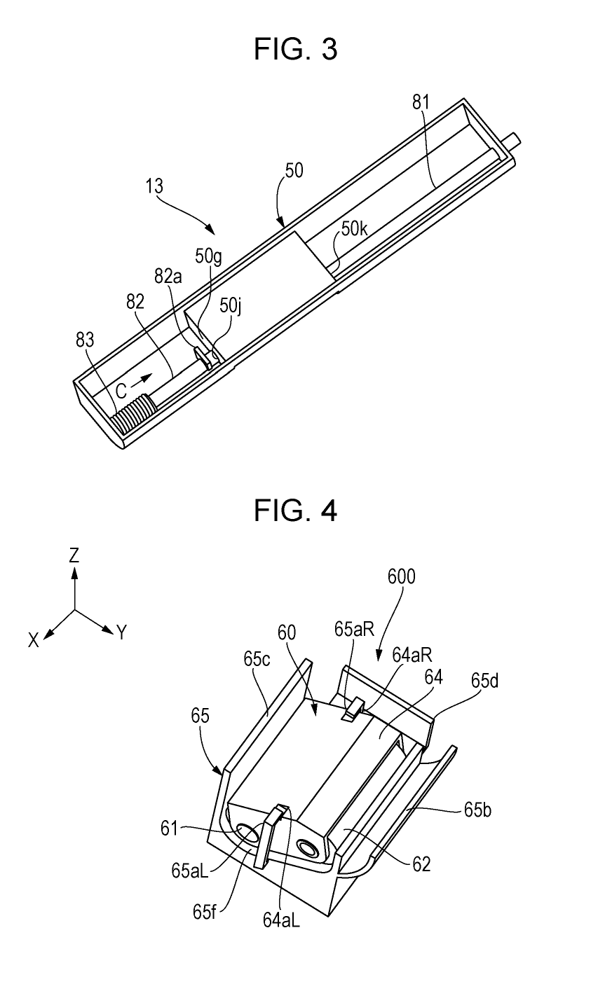

The detailed structure of the sheet-supplying device 13 according to the first embodiment will now be described. FIG. 2A is a perspective view of the sheet-supplying device 13 according to the first embodiment viewed from below. FIG. 2B is a perspective view of the sheet-supplying device 13 illustrated in FIG. 2A viewed at a different angle. FIG. 3 is a perspective view of the sheet-supplying device 13 illustrated in FIG. 2B viewed from above.

As illustrated in FIG. 2A, FIG. 2B, and FIG. 3, the sheet-supplying device 13 includes a supply frame 50 that is secured to the apparatus body 100a and the supply unit 60 that is supported by the supply frame 50 and supplies the sheet P from the inside of the sheet feed cassette 11. The supply frame 50 includes a supply drive shaft 81 and a slide shaft 82 that detachably support the supply unit 60 and a coil spring 83 formed of a compression spring that urges the slide shaft 82 in the direction of arrow C. The slide shaft 82 is supported slidably with respect to the supply frame 50 in the direction of arrow C.

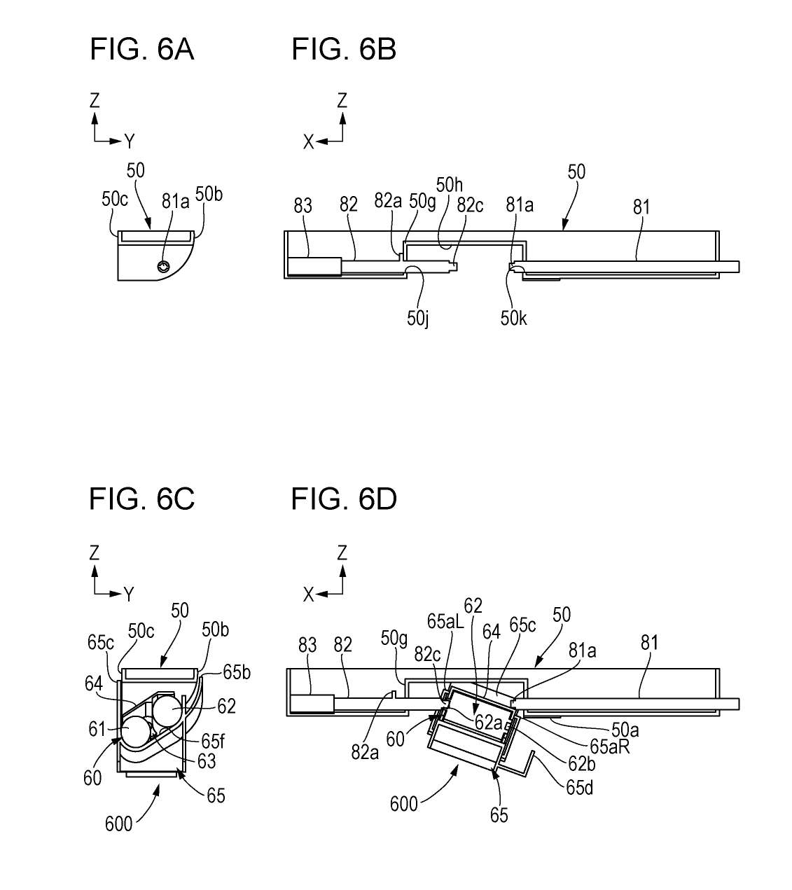

The supply unit 60 includes the pickup roller 61 (supplier), the feed roller 62 (conveyor), the idler gear 63 that is supported by a shaft 68 and transmits a driving force of the feed roller 62 to the pickup roller 61, and the supply holder 64. The supply holder 64 supports the pickup roller 61, the feed roller 62, and the idler gear 63. The supply holder 64 has a through-hole 64b formed such that the through-hole 64b faces a sliding end portion 82c (see FIG. 6A to FIG. 6D) of the slide shaft 82 and a through-hole 64c formed such that the through-hole 64c faces an engaging end portion 81a of the supply drive shaft 81. The feed roller 62 has a slide hole 62a (see FIG. 6A to FIG. 6D) formed such that the slide hole 62a faces the sliding end portion 82c of the slide shaft 82 and an engagement hole 62b (see FIG. 6A to FIG. 6D) formed such that the engagement hole 62b faces the engaging end portion 81a of the supply drive shaft 81.

The pickup roller 61 is rotatably supported by the supply holder 64 at a rotating shaft 67. The feed roller 62 is supported from both ends in the axial direction by the supply drive shaft 81 and the slide shaft 82. The supply frame 50 elongates in the axial direction and can receive the supply drive shaft 81 and the slide shaft 82. At a central portion thereof, a recessed portion 50h is formed, and the supply unit 60 is moveably accommodated in the recessed portion 50h. Through-holes 50j and 50k are formed so as to extend from the inside of the supply frame 50 and to be connected to a space in the recessed portion 50h. The supply unit 60 is rotatably accommodated in the recessed portion 50h of the supply frame 50 while being supported at both ends of the feed roller 62 by the slide shaft 82 and the supply drive shaft 81 that are respectively inserted into the through-holes 50j and 50k.

The sliding end portion 82c of the slide shaft 82 is inserted into the slide hole 62a (see FIG. 6D) formed in an end portion of the feed roller 62 in the axial direction. The feed roller 62 is supported by the shafts rotatably with respect to the slide shaft 82. The engaging end portion 81a of the supply drive shaft 81 is inserted into the engagement hole 62b (see FIG. 6D) formed in the other end portion of the feed roller 62 in the axial direction. The feed roller 62 is supported by the shafts such that the feed roller 62 cannot rotate with respect to the supply drive shaft 81.

As illustrated in FIG. 2A, a drive motor 69 that transmits rotation to the supply drive shaft 81 and causes the feed roller 62 to rotate, and a control unit 70 that includes CPU, RAM, and ROM and controls the drive motor 69 are disposed in the apparatus body 100a (see FIG. 1). When the drive motor 69 driven by control of the control unit 70 causes the feed roller 62 to rotate, the rotation is transmitted to the pickup roller 61 via the idler gear 63, causing the pickup roller 61 to rotate in the same direction as the feed roller 62 rotates. This enables the sheet in the sheet feed cassette 11 to be supplied.

As illustrated in FIG. 3, the slide shaft 82 is urged by the coil spring 83 in the direction of arrow C. When a slide stopping portion 82a formed on the slide shaft 82 so as to protrude comes into contact with a slide-stopped portion 50g formed on the supply frame 50, the slide shaft 82 stops at the position illustrated in FIG. 6A. The feed roller 62 is pressed toward the side of the supply drive shaft 81 by using the slide shaft 82 urged by the coil spring 83, and the supply unit 60 is thereby rotatably supported by the supply frame 50.

### Structure of Supply Unit and Vicinity Thereof

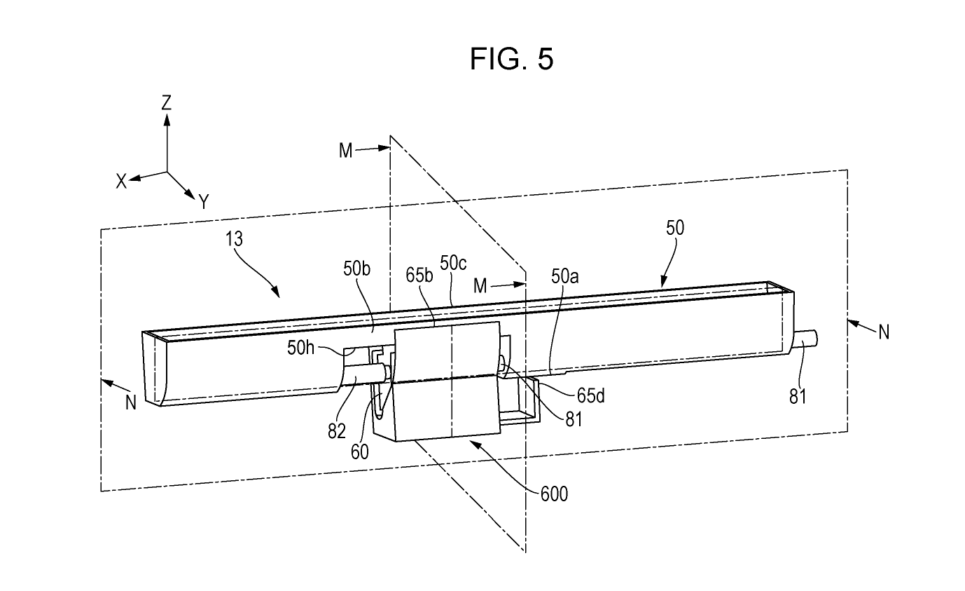

The structure of the supply unit 600 according to the first embodiment and the vicinity thereof will now be described with reference to FIG. 4 and FIG. 5. FIG. 4 is a perspective diagram illustrating the appearance of the supply unit 600 according to the first embodiment. FIG. 5 is a perspective diagram illustrating the appearance of the supply unit 600 and the sheet-supplying device 13.

As illustrated in FIG. 4 and FIG. 5, the supply unit 600 holds the supply unit 60, which includes the pickup roller 61 that supplies the sheet and the feed roller 62, for installation (replacement) and enables the supply unit 60 to be installed into the image forming apparatus 100 (detached from the image forming apparatus 100 and replaced). The supply unit 600 includes a roller-protecting member 65 (cover member). The roller-protecting member 65 has a roller-protecting surface 65f (cover portion) that covers the pickup roller 61 of the supply unit 60. The roller-protecting member 65 includes engaging pawls 65aL and 65aR (engaging portions) that can engage and integrally hold the supply unit 60 with the roller-protecting surface 65f covering the pickup roller 61. When the supply unit 60 has been installed into the supply frame 50 (installation portion) disposed on the image forming apparatus 100, the engaging pawls 65aL and 65aR (engaging portions) are disengaged and the roller-protecting member 65 is thereby detached from the supply unit 60.

The roller-protecting surface 65f (cover portion) of the roller-protecting member 65 is formed in a curved shape and covers the entire surface of the pickup roller 61 and the feed roller 62. The engaging pawls 65aL and 65aR are formed so as to protrude from left and right edge portions of the roller-protecting surface 65f. Bases of the engaging pawls 65aL and 65aR are formed integrally with the roller-protecting member 65, and pawl portions at free ends are flexible and bendable. Engagement recessed portions 64aL and 64aR are formed in both end portions of the upper surface of the supply unit 60.

The supply unit 60 includes the supply holder 64 that holds the pickup roller 61 (supplier) and the feed roller 62 (conveyor) that conveys the sheet P supplied by the pickup roller 61 to a downstream side in the direction in which the sheet is conveyed (direction of arrow M in FIG. 1). The supply unit 60 is held by the roller-protecting member 65 in a manner in which the engaging pawls 65aL and 65aR formed on the roller-protecting member 65 respectively engage the engagement recessed portions 64aL and 64aR, and can be detached from the roller-protecting member 65 in a manner in which the engaging pawls 65aL and 65aR disengage from the engagement recessed portions 64aL and 64aR.

As illustrated in FIG. 4 and FIG. 5, the supply frame 50 includes guided portions 50b and 50c above the recessed portion 50h located at a central portion in the longitudinal direction and restricted portions 50a at lower portions on both sides of the recessed portion 50h. The roller-protecting member 65 includes positioning guiding portions 65b and 65c (positioning contact portions) and a positioning restricting portion 65d (positioning contact portion). When the supply unit 60 held by the engaging pawls 65aL and 65aR is installed into the supply frame 50, the positioning guiding portions 65b and 65c and the positioning restricting portion 65d come into contact with the supply frame 50, and the position of the supply unit 60 with respect to the supply frame 50 is thereby set.

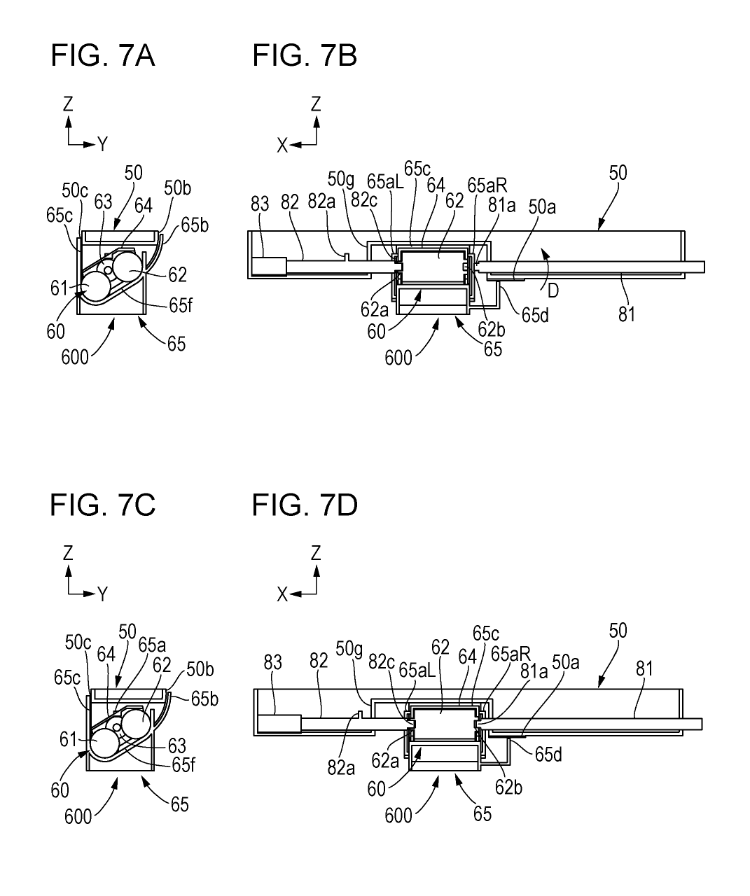

The positioning guiding portions 65b and 65c function as restricting units that restrict the guided portions 50b and 50c of the supply frame 50 in the direction (+Y) of arrow Y and the direction (−Y) opposite the direction of arrow Y. The positioning restricting portion 65d functions as a restricting unit that restricts one of the restricted portions 50a of the supply frame 50 in the direction of arrow Z. The positioning guiding portion 65c is formed so as to protrude and comes into contact with and engages the guided portion 50c of the supply frame 50 from the direction of arrow Y. The positioning guiding portion 65b is formed so as to slightly curve and protrude and comes into contact with and engages the guided portion 50b from the direction opposite the direction of arrow Y (see FIG. 7A to FIG. 7D). The positioning restricting portion 65d is formed so as to protrude and comes into contact with one of the restricted portions 50a of the supply frame 50 from the direction of arrow Z (see FIG. 7B and FIG. 7D).

### Supply Unit Installation

Installation of the supply unit 60 into the supply frame 50 of the sheet-supplying device 13 according to the first embodiment will now be described. FIG. 6A to FIG. 6D are sectional views of FIG. 5 after the sheet feed cassette 11 is drawn from the apparatus body 100a and the supply unit 60 is detached from the sheet-supplying device 13. FIG. 6A is a sectional view of FIG. 5 along line M-M, in the direction of arrows. FIG. 6B is a sectional view of FIG. 5 along line N-N, in the direction of arrows. FIG. 6C is a sectional view of FIG. 5 along line M-M, in the direction of the arrows, when the sliding end portion 82c of the slide shaft 82 is inserted into the slide hole 62a of the feed roller 62. FIG. 6D is a sectional view of FIG. 5 along line N-N, in the direction of the arrows, when the sliding end portion 82c of the slide shaft 82 is inserted into the slide hole 62a of the feed roller 62.

As illustrated in FIG. 6A to FIG. 6D, the slide shaft 82 (first support shaft) is disposed in the supply frame 50 and urged such that the sliding end portion 82c can be inserted into the slide hole 62a of the feed roller 62 (conveyance roller) formed at an end thereof. The supply drive shaft 81 (second support shaft), whose engaging end portion 81a can engage the engagement hole 62b of the feed roller 62 formed at the other end thereof, is disposed in the supply frame 50. The slide shaft 82 slides as a result of being urged in the −X direction (direction opposite the X direction) by the coil spring 83. When the slide stopping portion 82a of the slide shaft 82 comes into contact with the slide-stopped portion 50g, the slide shaft 82 stops at the position illustrated in FIG. 6B. In this state, the slide shaft 82 is caused to slide in the direction of arrow X against the urging force of the coil spring 83, and the supply unit 60 installed as illustrated in FIG. 2A and FIG. 2B can thereby be detached from the sheet-supplying device 13.

In a state in which the supply unit 60 including the pickup roller 61 subjected to wear and tear is detached from the supply frame 50, another supply unit 60 including a new pickup roller 61 for replacement thereof is installed into the supply frame 50. At this time, an operator inserts the sliding end portion 82c into the slide hole 62a of the feed roller 62 and inserts the engaging end portion 81a into the engagement hole 62b of the feed roller 62 while gripping the roller-protecting member 65 holding the supply holder 64. At this time, the engaging end portion 81a can properly mesh with a keyway of the engagement hole 62b in a manner in which the supply drive shaft 81 is slightly rotated, for example, through manual operation, and the supply unit 60 can be properly installed into the supply frame 50 with the feed roller 62 interposed therebetween.

As illustrated in FIG. 6C and FIG. 6D, the sliding end portion 82c of the slide shaft 82 is inserted into the slide hole 62a of the feed roller 62 of the supply unit 600 in the state illustrated in FIG. 6A and FIG. 6B. At this time, the positioning guiding portions 65b and 65c of the roller-protecting member 65 are in contact with the guided portions 50b and 50c of the supply frame 50, and movement of the supply unit 600 in the direction of arrow Y and in the opposite direction is thereby restricted. The position in the direction of arrow Z can be somewhat adjusted without restriction by visually inspecting the slide hole 62a and the sliding end portion 82c and adjusting accordingly. Accordingly, the restriction on the movement in the direction of arrow Y and in the opposite direction eliminates the misalignment of the slide hole 62a and the sliding end portion 82c, and the sliding end portion 82c can be readily inserted into the slide hole 62a.

FIG. 7A and FIG. 7B are sectional views of FIG. 5 before the supply unit 600 is installed in a normal state with respect to the sheet-supplying device 13. In the state illustrated in FIG. 6C and FIG. 6D, the supply unit 600 is swung in the direction of arrow D (FIG. 7B) on the side of the supply drive shaft 81, for example, through manual operation while the supply unit 600 and the slide shaft 82 are caused to slide in the +X direction (direction of arrow X) against the urging force of the coil spring 83.

At this time, the positioning guiding portions 65b and 65c of the roller-protecting member 65 are in contact with the guided portions 50b and 50c of the supply frame 50, and the movement in the +Y direction and in the −Y direction is thereby restricted. The positioning restricting portion 65d of the roller-protecting member 65 is in contact with one of the restricted portions 50a of the supply frame 50, and the movement in the direction of arrow Z is thereby restricted. At this time, the engagement hole 62b of the feed roller 62 is coaxial with the engaging end portion 81a of the supply drive shaft 81, and accordingly, the engaging end portion 81a can readily engage the engagement hole 62b in a subsequent process.

FIG. 7C and FIG. 7D are sectional views of FIG. 5 when the supply unit 600 is installed into the supply frame 50 of the sheet-supplying device 13. When the operator releases their grip to relieve the force acting against the urging force of the coil spring 83 in the state illustrated in FIG. 7A and FIG. 7B, the urging force of the coil spring 83 causes the supply unit 600 and the slide shaft 82 to move in the −X direction. In this way, the engaging end portion 81a of the supply drive shaft 81 properly engages the engagement hole 62b of the feed roller 62, and the supply unit 600 is installed into the sheet-supplying device 13 in a normal state.

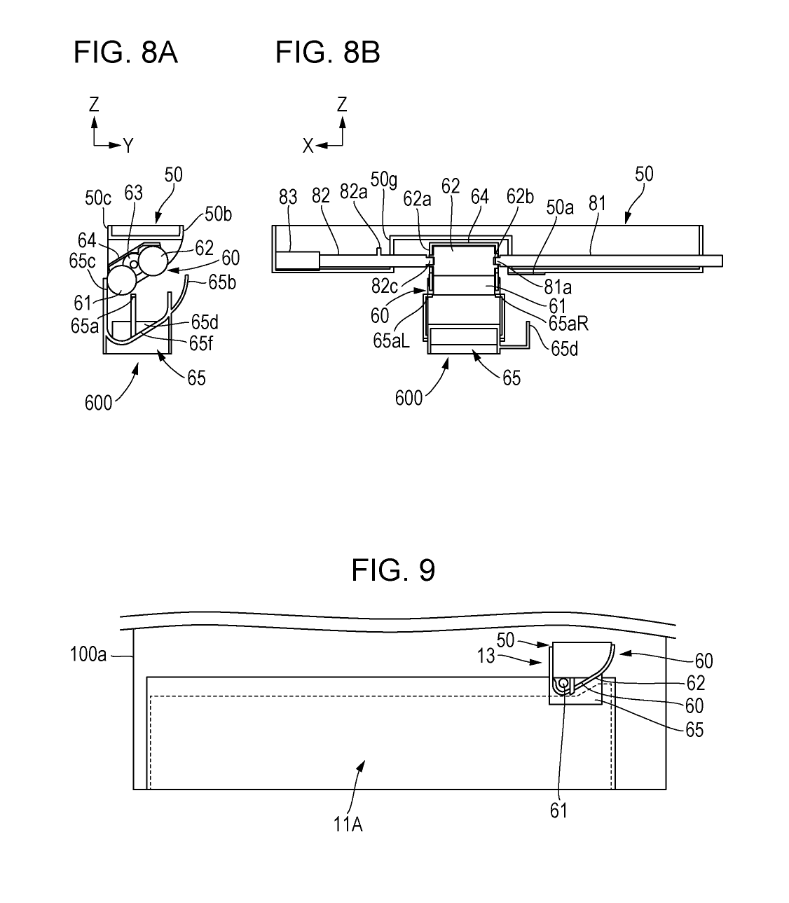

FIG. 8A and FIG. 8B are sectional views of FIG. 5 when the roller-protecting member 65 is detached from the supply unit 60. In the state illustrated in FIG. 7C and FIG. 7D, an operator moves the roller-protecting member 65 in the −Z direction (downward direction in FIG. 8A and FIG. 8B) with a force acting against the engagement of the engaging pawl 65aL and the engagement recessed portion 64aL and the engagement of the engaging pawl 65aR and the engagement recessed portion 64aR. In this way, the engaging pawl 65aL disengages from the engagement recessed portion 64aL, and the engaging pawl 65aR disengages from the engagement recessed portion 64aR. Consequently, the roller-protecting member 65 is detached from the supply unit 60, and, in this state, only the supply unit 60 is installed into the supply frame 50. Thus, the roller-protecting member 65 (cover member) is detached from the supply unit 60 by using the operator-applied operating force acting against the engaging force of the engaging pawls 65aL and 65aR (engaging portions) engaging the engagement recessed portions 64aL and 64aR (engaged portions).

FIG. 9 is a front view of the apparatus body 100a illustrating a state where the sheet feed cassette 11 is drawn from the apparatus body 100a, and the roller-protecting member 65 is installed into the sheet-supplying device 13. As illustrated in FIG. 9, the supply frame 50 is formed such that, in the case where the roller-protecting member 65 is not detached from the supply unit 60, the roller-protecting member 65 is located on a track of the sheet feed cassette 11 to be installed when the sheet feed cassette 11 is drawn from the apparatus body 100a. Accordingly, when the sheet feed cassette 11 is inserted, the sheet feed cassette 11 interferes with the roller-protecting member 65 that is not detached.

In other words, the roller-protecting member 65 installed into the sheet-supplying device 13 is disposed so as to protrude toward an area 11A in which the sheet feed cassette 11 is to be located. Accordingly, the sheet feed cassette 11 interferes with the roller-protecting member 65 while the sheet feed cassette 11 is being inserted into the area 11A and stops, even when an operator forgets to detach the roller-protecting member 65 from the supply unit 600. This reminds the operator that the roller-protecting member 65 has not yet detached. This is the same as in the case of a roller-protecting member 75 (cover member) according to a second embodiment described later.

In the first embodiment, the roller-protecting member 65 has the roller-protecting surface 65f that covers the rollers 61 and 62 and includes the engaging pawls 65aL and 65aR that can engage and integrally hold the supply unit 60 with the roller-protecting surface 65f covering the rollers 61 and 62. Accordingly, the roller-protecting member 65 enables an operator to inhibit from touching the surface of the pickup roller 61 during installation of the supply unit 60. This eliminates surface stains of the pickup roller 61 and the feed roller 62 and the occurrence of a supply failure. In addition, the roller-protecting member 65 functions as a guide during installation. This facilitates the operation by an operator and enables the operator to avoid a failure in installation. These effects are the same as in the second embodiment described later.

The engaging pawls 65aL and 65aR are disengaged to detach the roller-protecting member 65 when the supply unit 60 has been installed into the supply frame 50. Accordingly, the roller-protecting member 65 can be detached through a simple operation after the supply unit 60 is installed. The roller-protecting member 65 can be detached by using the operator-applied operating force acting against the engaging force of the engaging pawls 65aL and 65aR engaging the engagement recessed portions 64aL and 64aR. Accordingly, the detachment of the roller-protecting member 65 becomes easier.

The supply unit 60 includes the supply holder 64 that holds the feed roller 62 and the pickup roller 61. The engaging pawls 65aL and 65aR engage the engagement recessed portions 64aL and 64aR of the supply holder 64 and thereby integrally hold the supply unit 60. Accordingly, the supply unit 60 can be stably held by the roller-protecting member 65. This is the same as in the second embodiment described later.

When the supply unit 60 is installed into the supply frame 50, an operator can insert the sliding end portion 82c into the slide hole 62a of the feed roller 62 and insert the engaging end portion 81a into the engagement hole 62b of the feed roller 62 while gripping the roller-protecting member 65 holding the supply holder 64. This enables the supply unit 60 to be properly installed into the supply frame 50 with the feed roller 62 interposed therebetween. This is the same as in the second embodiment described later.

The roller-protecting member 65 includes the positioning guiding portions 65b and 65c and the positioning restricting portion 65d that come into contact with the supply frame 50 and thereby set the position of the supply unit 60 with respect to the supply frame 50 when the supply unit 60 held by the engaging pawls 65aL and 65aR is installed into the supply frame 50. Accordingly, when the supply unit 60 is installed into the supply frame 50, the position of the supply unit 60 with respect to the supply frame 50 can be successfully set in a manner in which the positioning guiding portions 65b and 65c and the positioning restricting portion 65d are brought into contact with the supply frame 50. This is the same as in the second embodiment described later.

### Second Embodiment

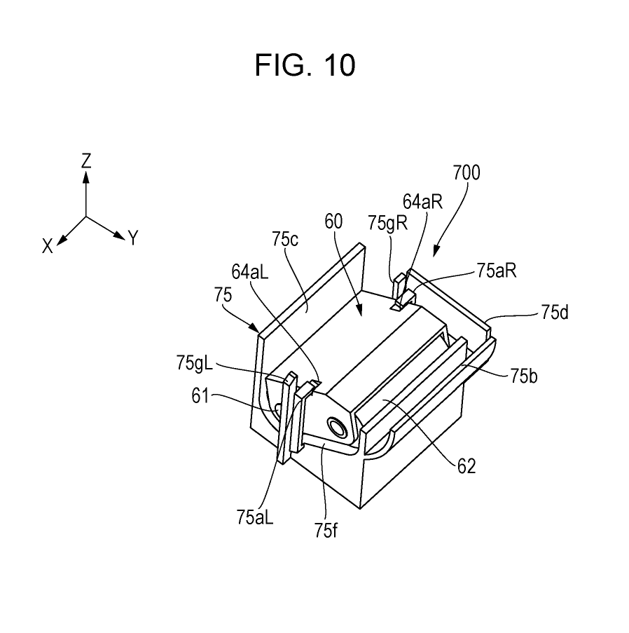

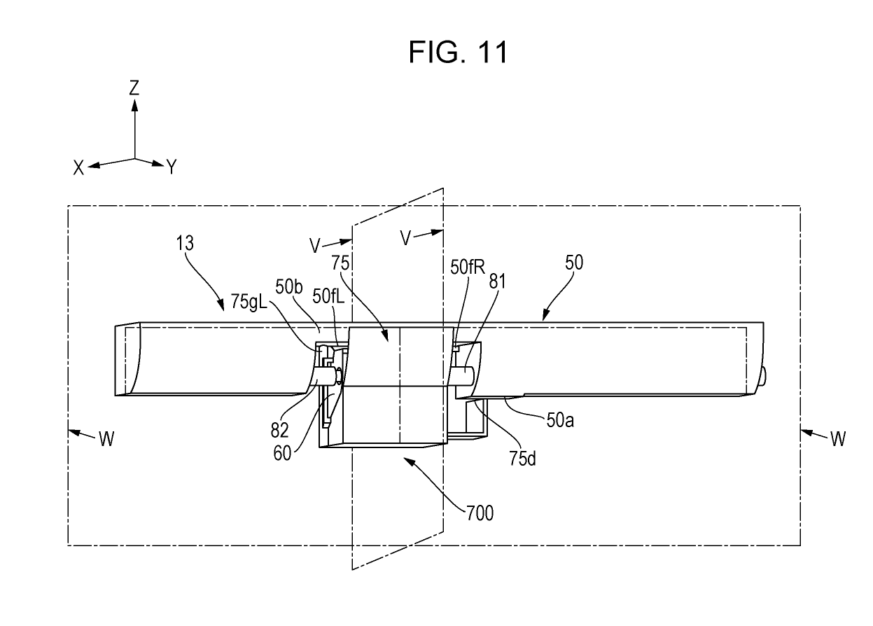

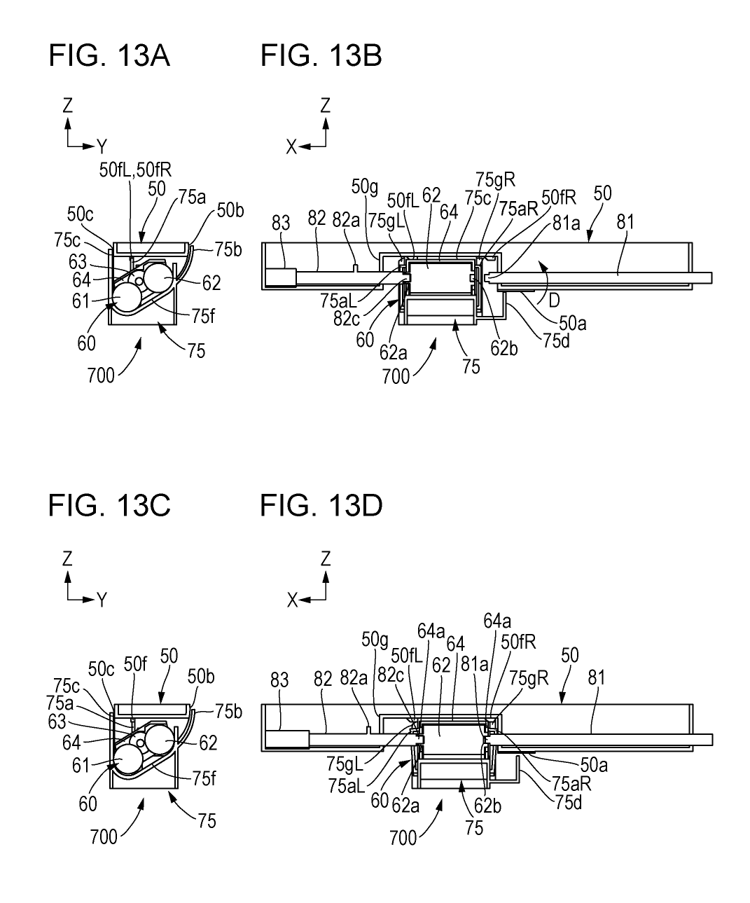

The second embodiment of the present invention will now be described with reference to FIG. 10, FIG. 11, and FIG. 13A to FIG. 13C. In the second embodiment, like symbols designate like components to those in the first embodiment, and a description of components having the same structure and function as in the first embodiment is omitted.

### Structure of Supply Unit and Vicinity Thereof

The structure of a supply unit 700 according to the second embodiment and the vicinity thereof will now be described with reference to FIG. 10 and FIG. 11. FIG. 10 is a perspective diagram illustrating the appearance of the supply unit 700 according to the second embodiment. FIG. 11 is a perspective diagram illustrating the appearance of the supply unit 700 and a sheet-supplying device 13 according to the second embodiment.

As illustrated in FIG. 10 and FIG. 11, the supply unit 700 according to the second embodiment includes a supply unit 60 having the same structure as described in the first embodiment and the roller-protecting member 75 (cover member) that is mounted on the supply unit 60.

The roller-protecting member 75 according to the second embodiment includes a roller-protecting portion 75f (cover portion) and engaging pawls 75aL and 75aR (engaging portions). The roller-protecting portion 75f is formed in a curved shape and covers the entire surface of the pickup roller 61 and the feed roller 62. The engaging pawls 75aL and 75aR are formed so as to protrude from left and right edge portions of the roller-protecting portion 75f. The engaging pawls 75aL and 75aR formed integrally with the roller-protecting member 75 are flexible. The engaging pawls 75aL and 75aR respectively engage the engagement recessed portions 64aL and 64aR formed in the supply unit 60 and thereby detachably hold the supply unit 60.

The supply frame 50 includes the guided portions 50b and 50c above the recessed portion 50h located at a central portion in the longitudinal direction and the restricted portions 50a at the lower portions on both sides of the recessed portion 50h. The supply frame 50 also includes protrusions 50fL and 50fR on the upper surface of the recessed portion 50h.

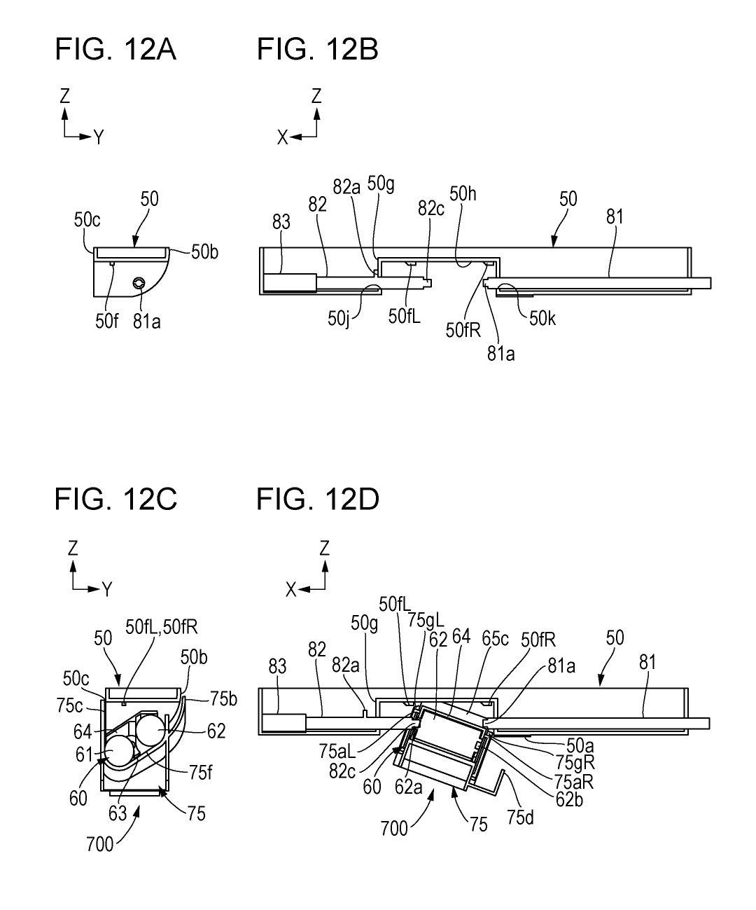

The roller-protecting member 75 includes positioning guiding portions 75b and 75c (positioning contact portions) serving as restricting units that restrict the guided portions 50b and 50c of the supply frame 50 in the direction of arrow Y and in the opposite direction. The roller-protecting member 75 also includes a positioning restricting portion 75d (positioning contact portion) serving as a restricting unit that restricts one of the restricted portions 50a of the supply frame 50 in the direction of arrow Z. The positioning guiding portion 75c is formed so as to protrude and comes into contact with and engages the guided portion 50c of the supply frame 50 from the direction of arrow Y. The positioning guiding portion 75b is formed so as to slightly curve and protrude and comes into contact with and engages the guided portion 50b from the direction opposite the direction of arrow Y (see FIG. 12A to FIG. 12D). The positioning restricting portion 75d is formed so as to protrude and comes into contact with one of the restricted portions 50a of the supply frame 50 from the direction of arrow Z (see FIG. 13B and FIG. 13D).

### Supply Unit Installation

Installation of the supply unit 60 into the supply frame 50 of the sheet-supplying device 13 according to the second embodiment will now be described. FIG. 12A is a sectional view of FIG. 11 along line V-V, in the direction of arrows. FIG. 12B is a sectional view of FIG. 11 along line W-W, in the direction of arrows. FIG. 12C is a sectional view of FIG. 11 along line V-V, in the direction of the arrows, when the sliding end portion 82c of the slide shaft 82 is inserted into the slide hole 62a of the feed roller 62. FIG. 12D is a sectional view of FIG. 11 along line W-W, in the direction of the arrows, when the sliding end portion 82c of the slide shaft 82 is inserted into the slide hole 62a of the feed roller 62.

As illustrated in FIG. 12A to FIG. 12D, the roller-protecting member 75 (cover member) includes interference protruding portions 75gL and 75gR that can interfere with the protrusions 50fL and 50fR formed on the supply frame 50. When the supply unit 60 held by the engaging pawls 75aL and 75aR (engaging portions) of the roller-protecting member 75 is installed into the supply frame 50, the interference protruding portions 75gL and 75gR interfere with the protrusions 50fL and 50fR. The reaction force at this time acts against the engaging force of the engaging pawls 75aL and 75aR (engaging portions) engaging the engagement recessed portions 64aL and 64aR, causing the engaging pawls 75aL and 75aR to disengage from the supply unit 60.

The slide shaft 82 slides as a result of being urged in the −X direction by the coil spring 83. When the slide stopping portion 82a of the slide shaft 82 comes into contact with the slide-stopped portion 50g of the supply frame 50, the slide shaft 82 stops at the position illustrated in FIG. 12B. In this state, the slide shaft 82 is caused to slide in the direction of arrow X against the urging force of the coil spring 83, and the supply unit 60 installed as illustrated in FIG. 2A and FIG. 2B can thereby be detached from the sheet-supplying device 13.

As illustrated in FIG. 12C and FIG. 12D, the sliding end portion 82c of the slide shaft 82 is inserted into the slide hole 62a of the feed roller 62 of the supply unit 700 in the state illustrated in FIG. 12A and FIG. 12B. At this time, the positioning guiding portions 75b and 75c of the roller-protecting member 75 are in contact with the guided portions 50b and 50c of the supply frame 50, and movement of the supply unit 700 in the direction of arrow Y and in the opposite direction is thereby restricted. The position in the direction of arrow Z can be somewhat adjusted without restriction by visually inspecting the slide hole 62a and the sliding end portion 82c and adjusting accordingly. Accordingly, the restriction on the movement in the direction of arrow Y and in the opposite direction eliminates the misalignment of the slide hole 62a and the sliding end portion 82c, and the sliding end portion 82c can be readily inserted into the slide hole 62a.

FIG. 13A and FIG. 13B are sectional views of FIG. 11 before the supply unit 700 is installed in a normal state with respect to the sheet-supplying device 13. In the state illustrated in FIG. 12C and FIG. 12D, the supply unit 700 is swung in the direction of arrow D (FIG. 13B) on the side of the supply drive shaft 81, for example, through manual operation while the supply unit 700 and the slide shaft 82 are caused to slide in the +X direction (direction of arrow X) against the urging force of the coil spring 83.

At this time, the positioning guiding portions 75b and 75c of the roller-protecting member 75 are in contact with the guided portions 50b and 50c of the supply frame 50, and the movement in the +Y direction and in the −Y direction is thereby restricted. The positioning restricting portion 75d of the roller-protecting member 75 is in contact with one of the restricted portions 50a of the supply frame 50, and the movement in the direction of arrow Z is thereby restricted. At this time, the engagement hole 62b of the feed roller 62 is coaxial with the engaging end portion 81a of the supply drive shaft 81, and accordingly, the engaging end portion 81a can readily engage the engagement hole 62b in a subsequent process.

When a user releases their grip to relieve the force acting against the urging force of the coil spring 83 in the state illustrated in FIG. 13A and FIG. 13B, the urging force of the coil spring 83 causes the supply unit 700 and the slide shaft 82 to move in the −X direction. In this way, the engaging end portion 81a of the supply drive shaft 81 properly engages the engagement hole 62b of the feed roller 62, and the supply unit 700 is installed into the sheet-supplying device 13 in a normal state.

At almost the same time, the two interference protruding portions 75gL and 75gR of the roller-protecting member 75 interfere with the two protrusions 50fL and 50fR formed on the upper surface of the recessed portion 50h of the supply frame 50, respectively. The interference creates a force acting against the engagement of the engaging pawls 75aL and 75aR of the roller-protecting member 75 and the engagement recessed portions 64aL and 64aR of the supply unit 60 (that is, a force that is transmitted through the interference protruding portions 75gL and 75gR and pushes the supply unit 60 downward). In this way, the engaging pawl 75aL disengages from the engagement recessed portion 64aL, and the engaging pawl 75aR disengages from the engagement recessed portion 64aR. Consequently, the roller-protecting member 75 is detached from the supply unit 60, and in this state, only the supply unit 60 is installed into the supply frame 50.

With the above structure, the surface of the pickup roller 61 is not touched and a supply failure can be inhibited during installation (replacement) using the supply unit 700. In addition, the roller-protecting member 75 functions as a guide during installation. This facilitates the operation by an operator and enables the operator to avoid a failure in installation. The roller-protecting member 75 is automatically detached from the supply unit 60 during installation. This further facilitates the installation and enables an operator to inhibit from forgetting to detach the roller-protecting member 75.

In the second embodiment, the interference protruding portions 75gL and 75gR that can interfere with the protrusions 50fL and 50fR formed on the supply frame 50 are formed. When the supply unit 60 held by the engaging pawls 75aL and 75aR is installed into the supply frame 50, the reaction force produced when the interference protruding portions 75gL and 75gR interfere with the protrusions 50fL and 50fR acts against the engaging force of the engaging pawls 75aL and 75aR engaging the recessed portions 64aL and 64aR. Accordingly, the roller-protecting member 75 is readily detached from the supply unit 60, and the detachment of the roller-protecting member 75 becomes easier.

The above embodiments are described by using the image forming apparatus 100 that is of an electrophotographic type. Alternatively, the embodiments can be applied to, for example, an ink-jet image forming apparatus that forms an image on a sheet by discharging ink from a nozzle.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A supply unit that is to be installed into an image forming apparatus, comprising:
a supply member that supplies a sheet;
a unit body that includes an engaged portion to be engaged and supports the supply member; and
a cover member that includes a cover portion that covers the supply member and an engaging portion that is to engage with the engaged portion, the cover member being detachable from the supply unit both in a state in which the supply unit has been installed into the image forming apparatus and in a state in which the supply unit has not been installed into the image forming apparatus.

2. The supply unit according to claim 1,
wherein the supply member is a supply roller that is rotatable about a shaft.

3. The supply unit according to claim 2, further comprising:
a conveyance member that conveys the sheet supplied by the supply member to a downstream side in a direction in which the sheet is conveyed,
wherein the unit body integrally holds the conveyance member and the supply member.

4. The supply unit according to claim 3,
wherein the cover member includes an interference portion that comes into contact with and interferes with part of the image forming apparatus, and
wherein the engaging portion disengages from the engaged portion such that the interference portion of the cover member interferes with the part of the image forming apparatus when the supply unit is installed into the image forming apparatus.

5. An image forming apparatus comprising:
an installation portion; and
a supply unit that is to be detachably installed into the installation portion and includes a supply member that supplies a sheet, a unit body that includes an engaged portion to be engaged and supports the supply member, a cover member that includes a cover portion that covers the supply member and an engaging portion that is to engage with the engaged portion,
wherein the cover member is detachable from the supply unit both in a state in which the supply unit has been installed into the image forming apparatus and in a state in which the supply unit has not been installed into the image forming apparatus.

6. The image forming apparatus according to claim 5,
wherein the supply member is a supply roller that is rotatable about a shaft.

7. The image forming apparatus according to claim 6, further comprising:
a conveyance member that conveys the sheet supplied by the supply member to a downstream side in a direction in which the sheet is conveyed,
wherein the unit body integrally holds the conveyance member and the supply member.

8. The image forming apparatus according to claim 7,
wherein the installation portion includes a first support shaft that is urged such that a sliding end portion thereof is to be inserted into a slide hole formed in one end portion of the conveyance member, and a second support shaft including an engaging end portion that is to engage with an engagement hole formed in the other end portion of the conveyance member, and
wherein the supply unit is installed into the installation portion with the conveyance member interposed therebetween such that the sliding end portion is inserted into the slide hole of the conveyance member and the engaging end portion is inserted into the engagement hole of the conveyance member.

9. The image forming apparatus according to claim 7,
where the cover member is detached from the supply unit by using an operator-applied operating force acting against an engaging force of the engaging portion engaging with the engaged portion.

10. The image forming apparatus according to claim 7,
wherein the cover member includes an interference protruding portion that is to interfere with a protrusion formed on the installation portion, and, when the supply unit held by the engaging portion is installed into the installation portion, a reaction force that is produced when the interference protruding portion interferes with the protrusion acts against an engaging force of the engaging portion engaging with the engaged portion, and the cover member is detached from the supply unit.

11. The image forming apparatus according to claim 7,
wherein the cover member includes a positioning contact portion that sets a position of the supply unit with respect to the installation portion by making contact with the installation portion when the supply unit held by the engaging portion is installed into the installation portion.

12. The image forming apparatus according to claim 7, further comprising:
a sheet-containing unit that is to be installed into and to be drawn from the image forming apparatus and is configured to contain the sheet to be supplied by the supply member; and
an image-forming unit that forms an image on the sheet supplied from the sheet-containing unit,
wherein the installation portion is formed such that, in a case where the cover member is not detached from the supply unit, the cover member is located on a track of the sheet-containing unit to be installed when the sheet-containing unit is drawn from the image forming apparatus, and the cover member interferes with the sheet-containing unit when the sheet-containing unit is installed.
